(19) United States
(12) Patent Application Publication
(10) Pub. No.: US 2015/0361697 A1
(43) Pub. Date: Dec. 17, 2015

(54) Door System

(71) Applicant: Krause Woodworking Kaliningrad AG, Kaliningrad (RU)

(72) Inventor: Karlheinz Krause, Finsterwalde (DE)

(21) Appl. No.: 14/654,741

(22) PCT Filed: Dec. 5, 2013
(86) PCT No.: PCT/EP2013/075648

§ 371 Date: Jun. 22, 2015

(30) Foreign Application Priority Data
Dec. 20, 2012 (DE) 202012105001.3

(51) Int. Cl. E05D 7/02; E06B 3/964; E06B 3/34; E05D 3/02; E05D 15/00; E06B 3/70

(52) U.S. Cl. CPC E05D 7/02; E05D 15/00; E06B 3/70; E06B 3/34; E05D 3/02; E06B 3/9642; E05D 2700/02

(57) ABSTRACT

A door system includes a non-folded door leaf (10) on which at least two barrels (20) are fixed on one side, and a frame (12) having two vertical legs (14, 16), one of which bears pivot hinges (24) for the barrels (20), the hinges (24) being arranged symmetrically in height relative to a horizontal center plane (B) of the frame (12), and fixing devices (22, 28) for fixing the barrels (20) on the door leaf (10) and for fixing the hinges (24) on the frame (12) such that each barrel and hinge has a 180° rotational symmetry relative to a horizontal axis (E, F).

The invention relates to a door system with a non-folded door leaf on which at least two hinge barrels are fixed on one side, and with a frame having two vertical legs, one of which bears pivot hinges for the barrels.

In some countries, in particular in Eastern Europe, so-called butt joint door systems are frequently used, wherein the door leaf has no fold.

It is an object of the invention to provide a door system of this type which can be manufactured and mounted more efficiently.

In order to achieve this object, according to the invention, the hinges are arranged symmetrically in height relatively to a horizontal center plane of the frame, and fixing devices for fixing the barrels on the door leaf and for fixing the hinges on the frame each have a 180° rotational symmetry relative to a horizontal axis.

Thanks to the rotational symmetry of the fixing devices it is possible to mount the barrels on the door leaf in two positions rotated by 180° relative to one another. Likewise can the hinges be mounted in two positions rotated by 180° against one another on the corresponding frame leg. This permits to use one and the same door system selectively for a right side hinged door and a left side hinged door. If the door is to be mounted as a right side hinged door, then the positions of the two vertical frame legs are interchanged in comparison to the mounting situation for a left side hinged door. Moreover, these legs are mounted with inverted orientation, so that the ends that face upwards for a left side hinged door will face downward for a right side hinge door. Would the arrangement of the hinges be left unchanged, this would have the consequence that the pivots of the hinges would point into the wrong direction, i.e. downwards. This, however, can be corrected by mounting the hinges in the reversed position, so that the pivots point upwardly again. Due to the symmetric arrangement of the hinges and the related parts of the fixing devices relative to the horizontal center plane of the frame, it is assured that the hinges will be in the same height for both a right side hinged door and a left side hinged door.

For a right side hinged door, the door leaf is mounted in a position rotated 180° about the vertical center axis in comparison to the mounting situation for a left side hinged door. Since the door leaf does not have a fold, it fits with the frame even in this rotated position. However, the rotation has the consequence that the barrels, in particular the eyelets thereof, project to the wrong side relative to the plane of the door leaf and therefore do not match with the positions of the pivots. Again, this may be corrected by mounting the barrels in a position rotated by 180°.

Thus, the invention also permits a method for converting a right side hinged door into a left side hinged door and vice versa, the method comprising the following steps:
interchanging the left and right vertical legs of the frame, and mounting these legs in a position in which top and bottom are interchanged,
reversing the mounting position of each hinge,
reversing the mounting position of each barrel at the door leaf, and
suspending the door leaf at the hinges in a position rotated 180° about the vertical center axis.

In this method, the order of the first three steps is arbitrary.

Useful details and further developments of the invention are indicated in the depending claims.

According to an independent aspect of the invention which may however be combined with the solution described above, the frame has a door post and a door case that are connected to one another by a bracket arranged on the outward side of the door post. The bracket and the outward surface of the door post form a gap into which a part of a door case may be inserted such that it is self-lockingly held by the bracket. In a preferred embodiment the door case is itself composed of two parts which may be inserted underneath the bracket from opposite sides. In another embodiment the door case may be composed of three parts, i.e. two blinds and a sheathing for the jamb of the door opening. In this case one of the blinds and the sheathing may be held by means of the bracket whereas the second blind is adapted to be connected to the sheathing by means of a snap-in profile. The sheathing which is essentially plate-shaped may be weakened along one or more vertical lines so that it can be adapted to different thicknesses of the wall by breaking or cutting along these lines.

The vertical legs and a horizontal top leg of the door frame are preferably connected by miter joints. To that end, connecting elements may be used, preferably of metal, which have the form of angle brackets the legs of which each have a trapezoidal profile that is open on the shorter side of the trapezoid. Then, the legs of the angle bracket may be inserted into complementary profiles of the horizontal leg and one vertical leg of the frame so as to form a stable corner joint.

In a particularly useful embodiment the vertical legs and the horizontal legs of the door post are pre-mounted in the door opening after they have been connected to one another. For that purpose, tightening fittings are used which pass through the horizontal leg of the door post and each of which carries at its top end a support plate which may be tightened, by means of a screw thread for example, against the inner surface of the door opening. Since the lower ends of the vertical legs of the door post are supported on the floor, the door post is stably mounted in the door opening while still being disposed at a certain distance from the jamb surfaces of the door opening. The gap between the door post and the jamb surfaces may be filled with expanding foam material before this gap is covered by means of the door case. The provisional mounting of the door post by means of the tightening fittings is so stable that the door leaf may be suspended before the foam material has expanded and cured. In this way, the door leaf may reinforce the door post and support it from inside, so that the force of the expanding foam may be better absorbed. Preferably, thin strips are adhered to the edges of the door leaf, these strips serving as spacers and determining the width of the rabbet between the door leaf and the frame. When the foam material has cured, the strips are removed, so that the door leaf will have equal play on all sides.

This method of mounting the door can also be taken advantage of independently of the features of claim 1.

An embodiment example will now be described in conjunction with the drawings, wherein:

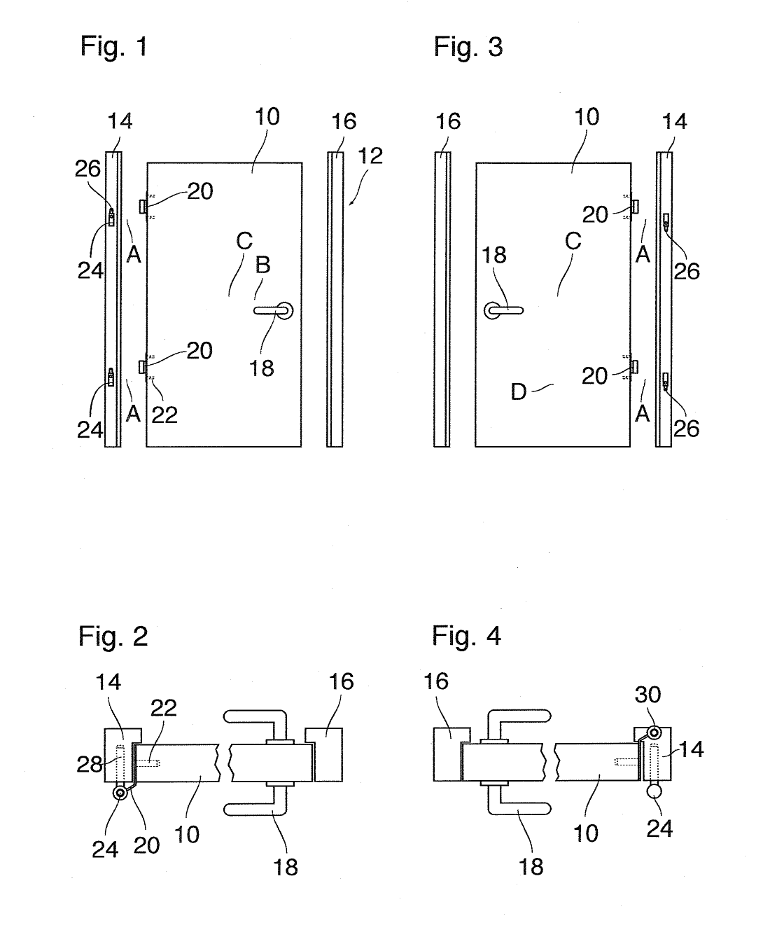

FIG. 1 is an exploded view of a left side hinged door;

FIG. 2 is a top-plan view of parts of the door shown in FIG. 1;

FIG. 3 is an exploded view analogous to FIG. 1, for an intermediate stage in a conversion of the door into a right side hinged door;

FIG. 4 is a top plan view corresponding to FIG. 3;

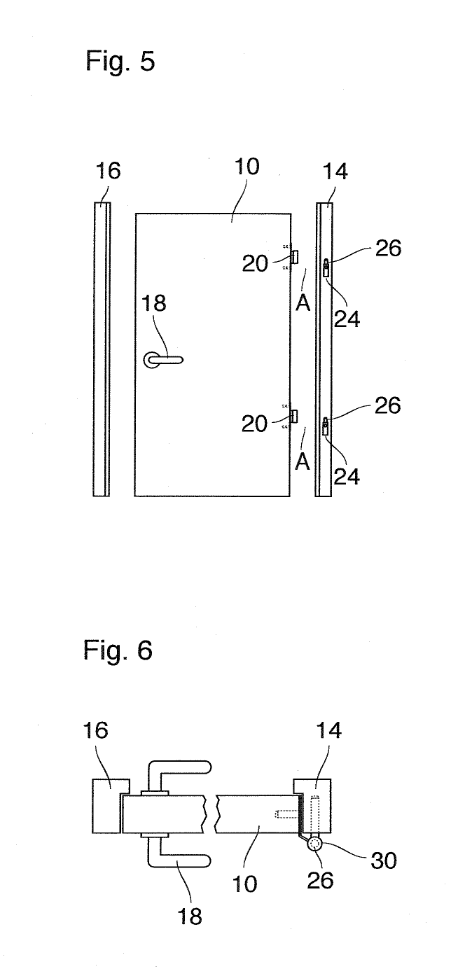

FIG. 5 is an exploded view of the door in the right side hinged configuration;

FIG. 6 is a top-plan view corresponding to FIG. 5;

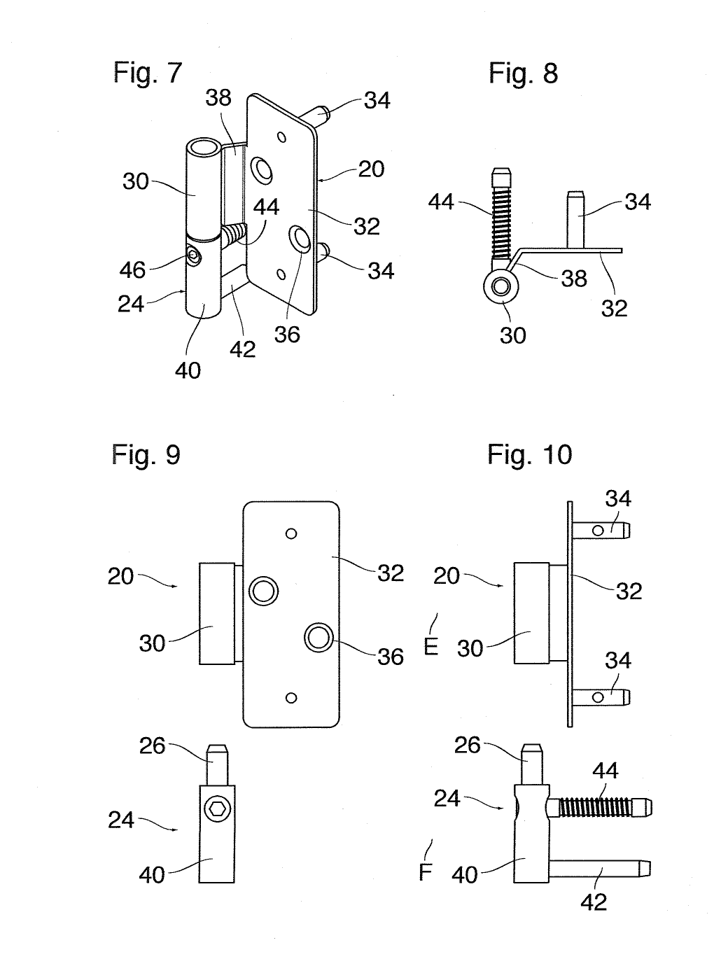

FIG. 7 is a perspective view of a door hinge assembly formed by a barrel and a hinge;

FIG. 8 is a top-plan view of the hinge shown in FIG. 7;

FIG. 9 is an exploded view of the barrel and the hinge:

FIG. 10 is an exploded view of the barrel and the hinge seen from a viewing direction rotated by 90° relative to FIG. 9;

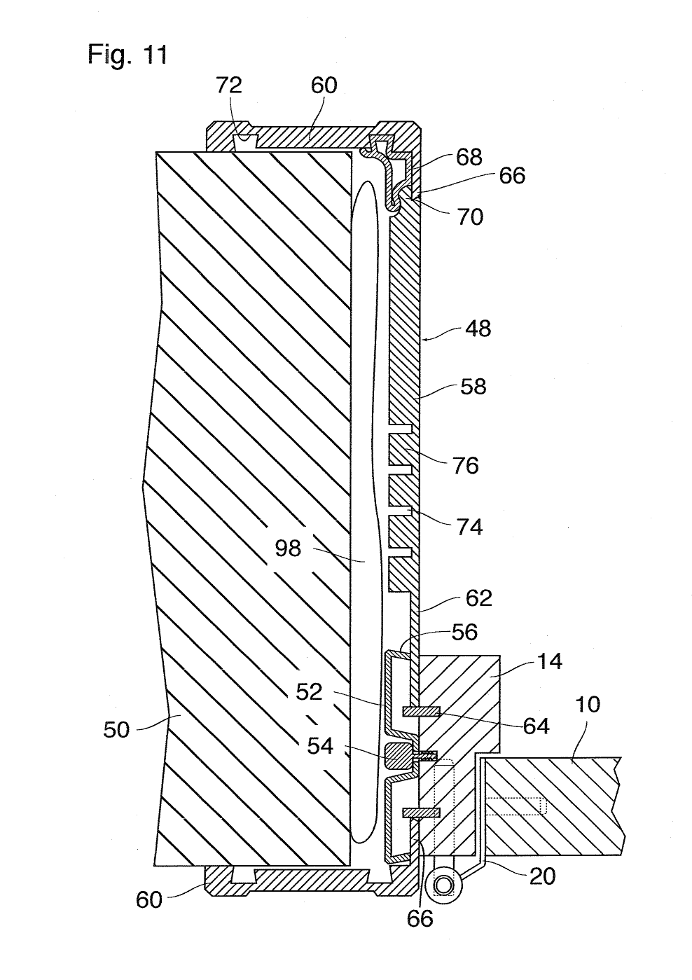

FIG. 11 is a horizontal cross-section of a complete door frame;

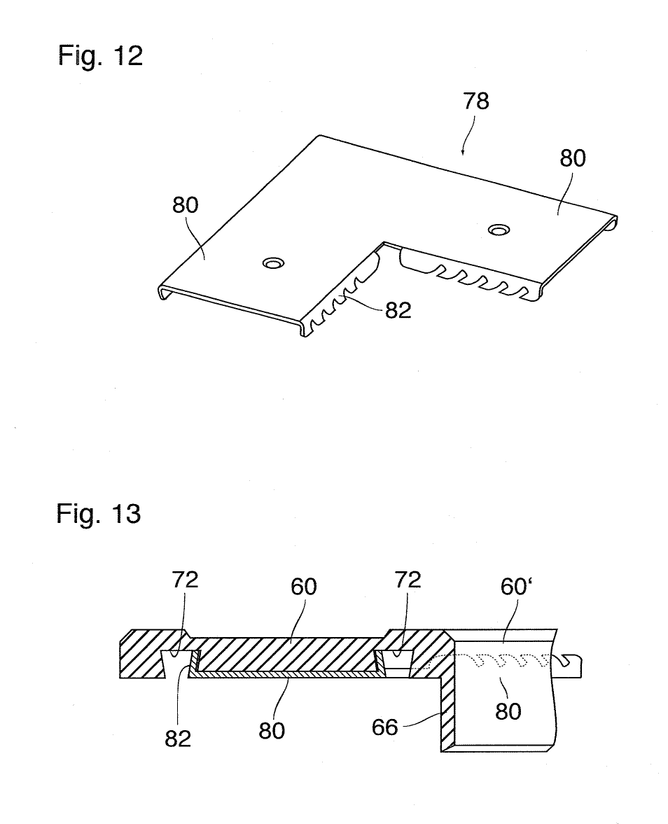

FIG. 12 is a perspective view of an angle bracket for connecting a vertical and a horizontal frame leg;

FIG. 13 is a cross-section of a frame leg together with a leg of the bracket shown in FIG. 12;

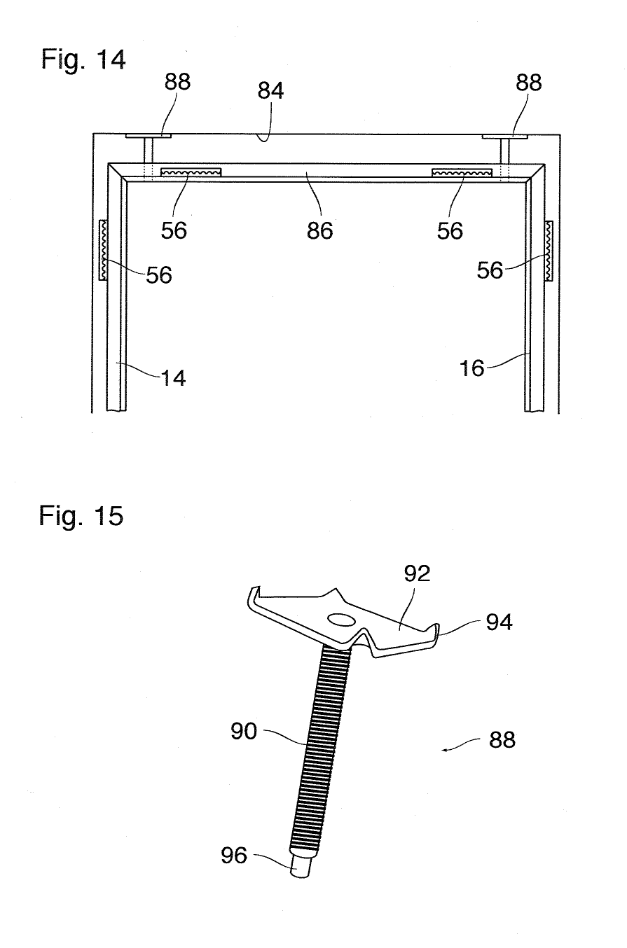

FIG. 14 is a view of a top part of a door opening having a door post immobilized by means of tightening fittings; and

FIG. 15 is a perspective view of a tightening fitting.

The door system which has been shown in a schematic exploded view in FIG. 1 comprises a non-folded door leaf 10 and a frame 12 of which only two vertical legs 14, 16 of a door post have been shown. The door leaf 10 has a handle 18 on the right side and, on the left side in FIG. 1, two barrels 20 fixed at the edge of the door leaf with corresponding fixing devices 22. Hinges 24 on which the door leaf may be suspended with the barrels 20 are mounted on the corresponding leg 14 of the frame. To that end, each hinge 24 has, as is common practice, an upwardly projecting pivot 26 engaging in an eyelet of the barrel 20.

As is shown in FIG. 2, the door leaf 10 has a rectangular cross-sectional shape without any folds, whereas the legs 14, 16 each have an L-shaped cross-section and thus form a fold in which the door leaf abuts with its butted edges. FIG. 2 further shows fixing devices 28 for the hinge 24.

The fixing devices 22 and 28 for the barrels 20 and the hinges 24 are respectively formed by two bores in the door leaf 10 and the leg 14, respectively, in which bolts of the barrel 20 and the hinge 24 are inserted, respectively, in this example. In FIG. 1, the center between the two bolts of the hinge 24 is indicated by a dot-dashed horizontal line A. Another dot-dashed horizontal line B marks the height of the centers of the two legs 14 and, therewith, a horizontal center plane of the frame 12. The two lines A are symmetric with respect to this center plane.

If desired, a right side hinged door may be formed with the components of the door system shown in FIG. 1. For the purpose of illustrating the method of mounting a right side hinged door, FIGS. 3 and 4 show an intermediate stage in the conversion of the left side hinged door according to FIG. 1 into a right side hinged door according to FIGS. 5 and 6.

As is shown in FIG. 3, on the one hand, the positions of the two legs 14 and 16 are interchanged. Moreover, the legs are mounted in inverted positions so that the ends which form the top ends in FIG. 1 will be the bottom ends in FIG. 3. In case of the leg 14 this can be recognized because the pivots 26 of the hinges point downwards in FIG. 3. This transformation corresponds to a rotation of the frame 12, i.e. in particular the two legs 14, 16, about an axis C which has been marked in FIGS. 1 and 3 by a dot-dashed cross and which extends normal to the plane of the drawing at the level of the line B. Due to the symmetric arrangement of the hinges 24 relative to the line B, the lines A in FIG. 3 are on the same level as in FIG. 1.

Moreover, in the transition from FIG. 1 to FIG. 3, the door leaf 10 has been rotated 180° about its vertical center axis D, so that the handle 18 is on the left side in FIG. 3, whereas the barrels 20 are on the right side. In this position, however, the door leaf cannot yet be suspended at the hinges 24. The reason is that the barrels 20 each have an eyelet 30 which receives the pivot 26 of the hinge and is disposed asymmetrically on one side of the door leaf. As can be seen in FIG. 4, this eyelet 30 is on the wrong side in the condition shown in FIGS. 3 and 4.

However, the fixing devices 22 and 28 for the barrels 20 and the hinges 24 each have a 180° rotational symmetry, so that the barrels and the hinges may be mounted at the door leaf 10 and at the leg 14, respectively, in two positions rotated by 180°. It is therefore possible to mount the hinges 24 in inverted position, so that their pivots 26 point upwardly again, and to mount the barrels 20 also in inverted position, so that the eyelet 30 is centered again on the pivot 26. In this way, one obtains the configuration of a right side hinged door as shown in FIGS. 5 and 6.

FIG. 7 is a perspective view of a door hinge assembly formed by one of the barrels 20 and the corresponding hinge 24. The barrel 20 has a base plate 32 with two non-threaded bolts 34 projecting therefrom, which bolts form the fixing device 22 together with corresponding bores in the door leaf. Additional screw holes 36 permit to mount the base plate 32 safely and detachably at the edge surface of the door leaf 10 while the bolts 34 engage in the bores and safely take up the weight of the door leaf.

On one vertical edge of the base plate 32, a web 38 has been formed which carries at its free end the eyelet 30 that has the shape of a vertical cylinder.

The hinge 24 has an essentially cylindrical support body 40 with a non-threaded bolt 42 and a threaded bolt 44 projecting therefrom at right angles. The threaded bolt 44 is rotatably supported in the support body 40 and has an internal hexagon 46, so that the threaded bolt may be screwed into the corresponding bore of the leg 14 whereas the non-threaded bolt 42 is inserted in the other bore of the leg.

The top plan view in FIG. 8 shows the threaded bolt 44 and one of the bolts 34 of the barrels 20, whereas the other bolt 34 and the non-threaded bolt 42 are hidden from view.

The exploded views in FIGS. 9 and 10 show the pivot 26 of the hinge 24 in a position aligned with the eyelet 30 of the barrel 20.

FIG. 10 further shows that the barrel 20 including the bolts 34 has a symmetric configuration with respect to an axis E. When the barrel is rotated 180° about this axis E, and the bolts 34 are inserted again into the corresponding bores of the door leaf, the eyelet 30, in particular, the lower end face thereof, will therefore have the same height as before.

Similarly, the non-threaded bolt 42 and the threaded bolt 44 are arranged symmetrically with respect to an axis F, so that the hinge 24 can also be mounted at the leg 14 in two positions rotated by 180° relative to one another. The support body 40 may also be configured symmetrically with respect to the axis F, so that the top end face in FIG. 10, which carries the pivot 26 and forms a support for the lower end face of the eyelet 30, has the same height in FIG. 5 and in FIG. 1. However, this arrangement is not compulsory. It is only required that a possible offset of the top end face of the support body 40 in height, which may occur in the transition from FIG. 1 to FIG. 5, is compensated by a corresponding offset in height of the lower end face of the eyelet 30 when the position of the barrel 20 is reversed. Under these conditions, it is assured that the door leaf 10 will have the same level relative to the frame in both the right side hinged configuration and the left side hinged configuration.

FIG. 11 shows, in a horizontal section, one end of the door leaf 10 with the barrel 20 suspended in the hinge and in the closed condition of the door, together with the complete door frame which comprises, in addition to the leg 14 of the door post, also a door case 48 that straddles a masonry 50 in which the door opening has been formed.

A metal bracket 52 with two symmetric wings is fixed on the outward side of the leg 14 facing the masonry 50. A center part of the bracket 52 engages the leg 14 and is fixed thereat with a plug 54 that penetrates the bracket 52 with a harpoon strip and is immobilized in a slot of the leg 14. The two wings of the bracket 52 are formed at their outer ends with flanges 56 that are bent back by more than 90° towards the leg 14 and form, together with the leg 14, a respective slot into which parts of the door case 48 may be inserted.

In the example shown, the door case 48 is composed of three parts, i.e. a sheathing 58 that covers the jamb of the door opening, and two identical blind profiles 60 that straddle the masonry 50.

The sheathing 58 is formed by a plate that is prolonged at the edge facing the leg 14 of the door post by a thinner web 62. This web has been pushed through the slot formed between the flange 56 and the bracket 52 and against an abutment 64 which is held in a groove of the leg 14. The flange 56 of the bracket 52 clamps the web 62 in the slot, and, due to the position of the flange 56 angled by more than 90°, a self-locking effect is obtained if one attempts to withdraw the web 62 from the slot, upwards in FIG. 11.

A web 66 of the lower blind profile 60 in FIG. 11 is held in a corresponding manner by the other wing of the bracket 52.

The upper blind profile 60 in FIG. 11 is connected to the sheathing 58 by a clamp profile 68. On the side facing away from the wall, the edge of the sheathing 58 forms a shallow groove in which the web 66 is received so as to be flush with the sheathing. This groove is delimited by a tongue 70 forming a snap bulge for the clamp profile 68.

The blind profile 60 has two dovetail grooves 72 on its inner side. The clamp profile 68 has a dovetail profile complementary to and inserted into one of the dovetail grooves 72. In this way, the clamp profile 68 is fixed at the blind profile 60. Then, the clamp profile and the blind profile may be snap-fastened at the edge of the sheathing 58, with a nose formed by the clamp profile 68 snapping-in behind the bulge of the tongue 70. The clamp profile 68 may for example be an elastic hollow profile of plastic or metal.

The sheathing 58 may for example be a plate of wood or timber product, e.g. fiberboard, and is, in this example, weakened on the side facing the masonry 50 by several grooves 74 that extend in parallel with the edge formed by the web 62. If the masonry 50 has a smaller thickness and, consequently, a sheathing with a smaller width is needed, then a part of the sheathing can be broken away at one of the grooves 74. Then, one or more of the webs 76 formed between the grooves 74 is cut away, with a broach for example, so that the edge of the plate is formed again a thinned web which may be inserted into the slot delimited by the clamp 52 in order to fix the sheathing at the leg 14 of the door post.

In general, the door frame 12 will comprise not only the two vertical legs but also a horizontal top leg that interconnects the two vertical legs. This top leg may also comprise a door post leg and a door case leg which will be formed of the same profiles as in FIG. 11. At the corners, the frame profiles are connected by miter joints.

FIG. 12 shows an angle bracket 78, preferably made of metal, that may be used for stabilizing and reinforcing the miter joint between the blind profiles 60. The angle bracket has two legs 80 extending at right angles to one another and each being bent to form a shallow trapezoidal profile, with the shorter side of the trapezoid (lower side in FIG. 12) being omitted. The tapering flanges 82 that form the flanks of the trapezoid are toothed at the lower edge in FIG. 12.

In FIG. 13, a vertically extending blind profile 60 has been shown in cross-section, and one end of a horizontal blind profile 60 forming a miter joint with the blind profile 60 is shown in a bottom view (viewing on the web 66). The two blind profiles are thrust onto the legs 80 of the angle bracket 78 such that the flanges 82 of the trapezoidal profile each engage in one of the dovetail grooves 72. The center part of the blind profile that is delimited by the dove tail grooves 72 (and has again a dovetail profile) is thereby fitted and slightly clamped in the profile of the angle bracket, with the tooting of the flanges 82 biting into the bottom of the dovetail grooves 72 and preventing the blind profile from being withdrawn. In this way, the miter joints between the blind profiles on both sides of the door can be formed with identical angle brackets 78. The flanges 82 of the angle bracket will then also engage in the one of the dovetail grooves 72 that accommodates (in another section of its length) the clamp profile 68 as shown in FIG. 11. It will be understood that the clamp profiles 68 may be relatively short profile members forming only a segmental connection between the blind profile and the sheathing. Further, it can be seen in FIG. 11 that the center part of the blind profile 60 that is delimited by the dove tail 72 is slightly offset from the inner surface of the blind profile, namely just by the thickness of the corresponding wall part of the angle bracket 78. This assures that the blind profile 60 will smoothly engage the masonry 50 at its outer edge (on the left side in FIG. 11).

What will now be described is a method by which the door system that has been disclosed here can be installed in a door opening in a particularly efficient and safe way. FIG. 14 shows a top part of a door opening 84 as well as the two vertical legs 14, 16 and a horizontal leg 86 of the door post. The horizontal leg 86 forms rigid miter joints with the vertical legs 14, 16, as is known in the art, and is connected to these vertical legs for example by means of known corner connectors. The frame that has been formed in this way is placed in the door opening 84 such that the vertical legs 14, 16 are supported on the floor with their lower ends and have some play between the lateral faces of the masonry. Correspondingly, the horizontal leg 86 has some play relative to the upper end of the door opening.

At two points, preferably near the opposite ends, the horizontal leg 86 is penetrated by two tightening fittings 88. A single tightening fitting 88 has been shown in a perspective view in FIG. 15. It comprises a threaded bolt 90 and a support plate 92 that is supported rotatably at the top end of the threaded bolt. The corners of the support plate 92 are bent to form claws 94 with which the support plate can dig into the lintel or masonry that forms the upper limit of the door opening 84. The threaded bolt 90 has a tool engagement portion 96 at its lower end and is screwed from above into a corresponding threaded bore of the horizontal leg 86 such that the tool engagement portion 66 is exposed at the bottom side of the leg 86. Then, in the position shown in FIG. 14, the threaded bolt is screwed-out by means of the tool until the support plate 92 presses firmly against the edge of the door opening. In this way, the door post frame which is supported on the floor with the lower ends of the legs 14, 16 is safely clamped in the door opening.

FIG. 14 shows also the flanges 56 of some of the brackets 52 that have been described in conjunction with FIG. 11 and serve for fixing the door case. In the example shown, the flanges 56 are toothed at the edge that delimits the slot for the webs 62, 66.

Before the door case 48 is fixed at the brackets 52 in the manner shown in FIG. 11, an expandable foam material 98 such as a PU foam is applied on the inner surface of the door opening. Subsequently, the door case 48 is mounted and the door leaf 10 is suspended at the hinges 24 of the door post which is tightly held by the tightening fittings 88. Preferably, the adhesive spacer strips are attached to the edges of the door leaf 10 such that, when the door is closed, the gap between the door leaf and the legs of the door post is completely filled by the spacer strips, so that the door can only be closed by overcoming a certain resistance. Then, when the door is closed, these spacer strips serve as spacers, and the door post frame formed by the legs 14, 16 and 86 is stiffened by the door leaf 10 while the foam 98 expands. Then, when the foam has cured, the door frame including the door post is safely fixed at the wall. When the door has been opened, the spacer strips are removed so that the door will have play in the folds of the door post on all sides.

What is claimed is:

1. A door system comprising:
a non-folded door leaf,
at least two barrels fixed on one side of the door leaf,
a frame having two vertical legs,
pivot hinges for the barrels mounted to one of the vertical legs, the hinges being arranged symmetrically in height relative to a horizontal center plane of the frame, and
fixing devices for fixing the barrels on the door leaf and for fixing the hinges on the frame such that each of the barrels and hinges has a 180° rotational symmetry relative to a horizontal axis.

2. The door system according to claim 1, wherein the fixing devices are respectively formed by two parallel bolts at the barrel and the hinge, respectively, and by associated bores in the door leaf and the respective leg.

3. The door system according to claim 2, wherein the barrels each have a base plate which engages an edge of the door leaf and bears an eyelet for a pivot of a respective said hinge, the eyelet being arranged asymmetric with respect to a plane of the base plate, the bolts projecting at right angles from the base plate and engaging in corresponding bores in an edge face of the door leaf.

4. A door system according to claim 1, wherein the legs of a door post of the frame each have, on an outer surface, an elastic bracket bearing at an outer end a flange that is inclined relative to a plane of the outer surface of the leg and forms, together with the outer surface of the leg, a slot for inserting a web of a part of a door case.

5. The door system according to claim 4, wherein the bracket is fixed at the leg by a plug that is fixed in a groove of the leg by a harpoon strip penetrating the bracket.

6. The door system according to claim 4, wherein the bracket has two symmetric wings, each of which bears one flange.

7. The door system according to claim 4, wherein the door case comprises two identical blind profiles, each of which has a respective said web adapted to be inserted into a respective said slot formed by one said bracket.

8. The door system according to claim 4, wherein the door case comprises a plate-like sheathing member having said web adapted to be inserted into the slot formed by the bracket.

9. The door system according to claim 8, further comprising a clamp profile which snap-fastens an edge of the sheathing member on a side opposite to the web, and a blind profile.

10. The door system according to claim 9, wherein the clamp profile comprises a dovetail profile adapted to be inserted axially into a dovetail groove of the blind profile.

11. The door system according to claim 8, wherein the sheathing member is weakened by at least one groove extending longitudinally on a side facing outwardly with respect to the door opening.

12. A door system according to claim 1, wherein the frame has, at least on one side, blind profiles that are connected to one another by miter joints, and further comprising an L-shaped metal angle bracket for holding together the blind profiles, the bracket having legs, each of which comprises two flanges bent at an angle of more than 90°, said flanges engaging in a complementary dovetail profile of the respective blind profile.

13. The door system according to claim 12, wherein the flanges of the angle bracket have toothed edges.

14. The door system according to claim 12, wherein the dovetail profile for engagement of the angle bracket is limited on one side by a dovetail groove of one said blind profile which accommodates, in another section of a length thereof, a trapezoidal profile of a clamp profile.

15. A door system according to claim 1, wherein the frame has a horizontal leg and further comprising at least two tightening fittings, each having a threaded bolt screwed into a vertical threaded bore of the horizontal leg and carrying at an upper end a support plate that is rotatable relative to the threaded bolt and engages a top edge of a door opening, the threaded bolt having a tool engagement portion permitting to rotate the threaded bolt and thereby to tighten the frame in the door opening.
